(19) United States
(12) Patent Application Publication
(10) Pub. No.: US 2005/0030750 A1
(43) Pub. Date: Feb. 10, 2005

(54) Method and device for operating a fluorescent tube in an energy saving manner

(76) Inventors: Ewald Ehmen, Wittmund (DE); Jurgen Schneider, Meerbusch (DE); Karl-Heinz Stutzer, Meerbusch (DE)

Correspondence Address: Randolph A Smith;Smith Patent Office, Suite 200, 1901 Pennsylvania Avenue, Washington, DC, 20006-3433, US

(21) Appl. No.: 10/487,933

(22) PCT Filed: Sep. 3, 2002
(86) PCT No.: PCT/DE02/03244

(30) Foreign Application Priority Data
Sep. 4, 2001 (DE) 201 14 623.1

(51) Int. Cl. F21K 2/00; H01J 13/46

(52) U.S. Cl. 362/260; 315/32

(57) ABSTRACT

The invention relates to an energy-saving operating method and an apparatus for energy-saving operation of a fluorescent tube, especially a T5 fluorescent tube. In a first operating mode, heat current is applied to an incandescent filament at one end of the fluorescent tube. Moreover, in the first operating mode, another heat current is applied to another incandescent filament at an end of the fluorescent tube opposite to said one end. The other incandescent filament is connected to energy-saving circuitry. In a second operating mode, the application of the heat current to the incandescent filament and of the other heat current and the other incandescent filament is interrupted. Monitoring means are provided, which are comprised by electronic circuitry, to monitor an operating parameter of the other incandescent filament in the first and second operating modes. The electronic circuitry controls a time period of application of the other heat current to the other incandescent filament in dependence on a time period of application of the heat current to the incandescent filament, in response to the operating parameter being monitored.

The invention relates to an energy-saving operating method and an apparatus for energy-saving operation of a fluorescent tube, especially a T5 fluorescent tube.

It is frequent practice nowadays to operate T5 fluorescent tubes in holders made for T8 fluorescent tubes which means that existing lamp holders for older T8 fluorescent tubes are being made use of for modern T5 fluorescent tubes. To be able to do that, a first adapter is disposed at a first end of the T5 fluorescent tube and a second adapter is disposed at a second end of the T5 fluorescent tube in order to compensate a difference in length between the shorter T5 fluorescent tubes and the longer T8 fluorescent tubes. An electronic ballast means (EVG) is arranged at the second adapter so as to have the fluorescent tube perform in energy-saving manner. To this end, the electronic ballast means generates a high frequency voltage and controls switch-on and switch-off of a heat current for preheating the incandescent filaments provided at the two ends of the T5 fluorescent tube prior to the ignition of the T5 fluorescent tube and also in the dimming mode. For optimum operation of the T5 fluorescent tube, heat current must be supplied simultaneously to the incandescent filaments at both ends of the T5 fluorescent tube. Electronic circuitry provided at the second adapter controls the supply of heat current to the incandescent filament at the first end of the T5 fluorescent tube. At the other end, this task is accomplished by the electronic ballast means.

It is known from the international patent application PCT/DE01/04139 to transmit a signal optically, especially in the infrared spectral range, or through an additional signal line from the electronic ballast means to the electronic circuitry for synchronizing the switch-on and switch-off of the heat current at the two ends of the T5 fluorescent tube. It is a disadvantage of the optical signal transmission that the light path can be disturbed by such things as dust or particles. Use of an additional line makes it necessary to lay such a line which involves extra costs and thus is disadvantageous, too.

It is the object of the invention to provide an improved method and an improved apparatus for energy-saving operation of a fluorescent tube, especially a T5 fluorescent tube, permitting the heat current at the incandescent filament of the fluorescent tube to be controlled independently of any unfavorable external influences.

This object is met, in accordance with the invention, by a method according to independent claim 1 and apparatus according to independent claims 5 and 8.

As an essential concept, the invention provides for monitoring an operating parameter of the incandescent filament at one end of the fluorescent tube, formed opposite another end of the fluorescent tube. An electronic ballast means (EVG) is arranged at the other end of the fluorescent tube. Monitoring of the operating parameter is effected by monitoring means belonging to electronic circuitry which controls switch-off/switch-on of the heat current for the incandescent filament at the one end in response to the operating parameter being monitored. No signals are exchanged between the electronic circuitry and the energy-saving means via an optical transmission path or a signal line, as provided in the prior art. Therefore, conditions during operation of the fluorescent tube that might obstruct the signal transmission between the energy-saving means and the electronic circuitry are prevented from having any influence on the automatic control of the application of heat current to the incandescent filament at the one end. The fluorescent tubes thus can be operated reliably in energy-saving fashion even under operating conditions which occur, for instance, when moisture or dirt cause deposits to form on the fluorescent tube or associated components, thereby obstructing the optical signal transmission. The field of application of the energy-saving means is broadened accordingly.

Monitoring of the operating parameter of the incandescent filament which is not coupled to the energy-saving means makes it possible to synchronize the timing of switch-on/switch-off of the heat currents supplying the incandescent filament as well as the duration of the application of heat current to the incandescent filament which is coupled to the energy-saving means. Hereby, the application of the respective heat current to two incandescent filaments either can be shifted in time with respect to each other or be carried out simultaneously. This is true both for switch-on and switch-off of the heat current.

An operating parameter especially well suited for being monitored by monitoring means of the electronic circuitry is a maintaining voltage dependent on frequency at the other incandescent filament which is not coupled to the electronic ballast means.

The frequency-dependent maintaining voltage may be used conveniently to induce a voltage dependent on frequency in a resonant circuit and make use of said voltage as an indicator of the need to switch-on/switch-off the heat current for the incandescent filament. When operating the fluorescent tube in a dimming mode the frequency of the maintaining voltage changes at the incandescent filament not coupled to the electronic ballast means. This change in frequency and the resulting different voltage induced in the resonant circuit are utilized as a control signal for varying the application of heat current to the incandescent filament. The electronic circuitry which is formed separately of the electronic ballast means and coupled to the incandescent filament is designed in such a way that the control of the heat current at the incandescent filament, in response to the operating parameter monitored, is performed automatically.

The method and apparatus with which an operating parameter of the incandescent filament is taken as the starting base for control of the application of heat current to the incandescent filament can be utilized conveniently to obtain energy-saving performance of a T5 fluorescent tube. When T5 fluorescent tubes are used in a lamp holder originally provided for a different fluorescent tube model, such as a T8 lamp, the electronic ballast means and/or the electronic circuitry may be integrated in adapters serving to hold the T5 lamp in the conventional holder.

Based on an embodiment, the invention will be explained below with reference to a drawing, in which:

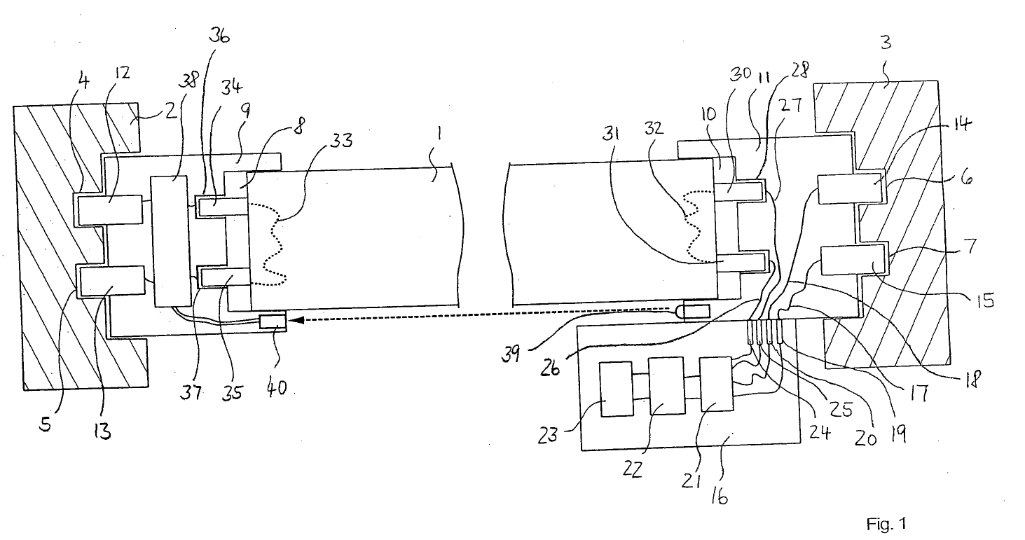

FIG. 1 shows an arrangement for energy-saving operation of a T5 fluorescent tube in two T8 fluorescent tube holders;

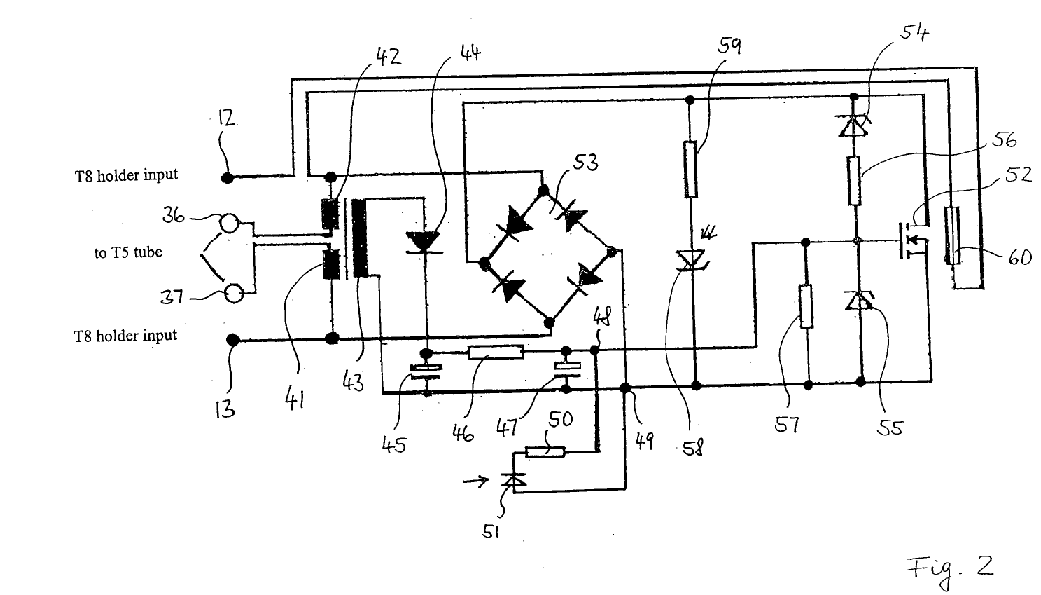

FIG. 2 shows electronic circuitry for control of the heat current of an incandescent filament at the end remote from the electronic ballast means of a T5 fluorescent tube in the arrangement illustrated in FIG. 1;

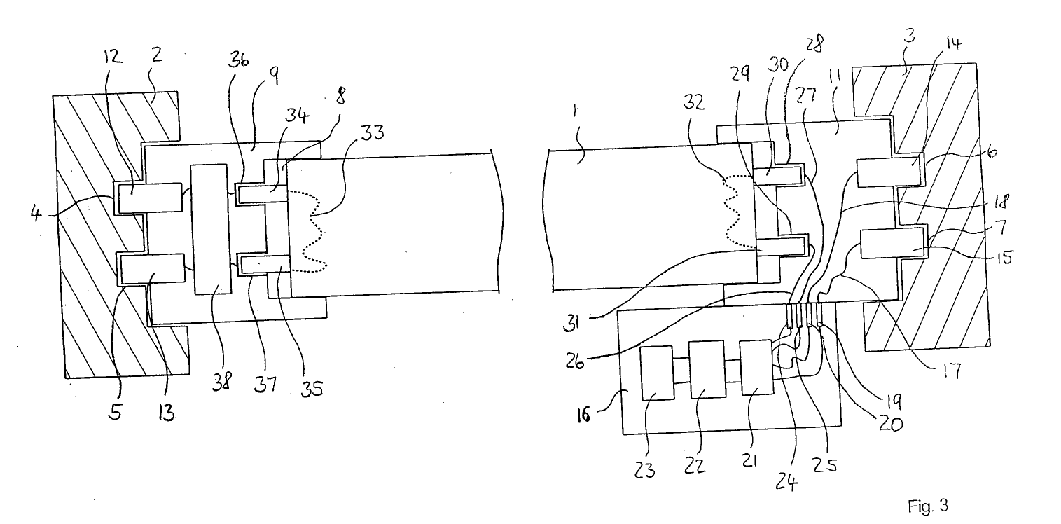

FIG. 3 shows another arrangement for energy-saving operation of a T5 fluorescent tube in two TB fluorescent tube holders; and

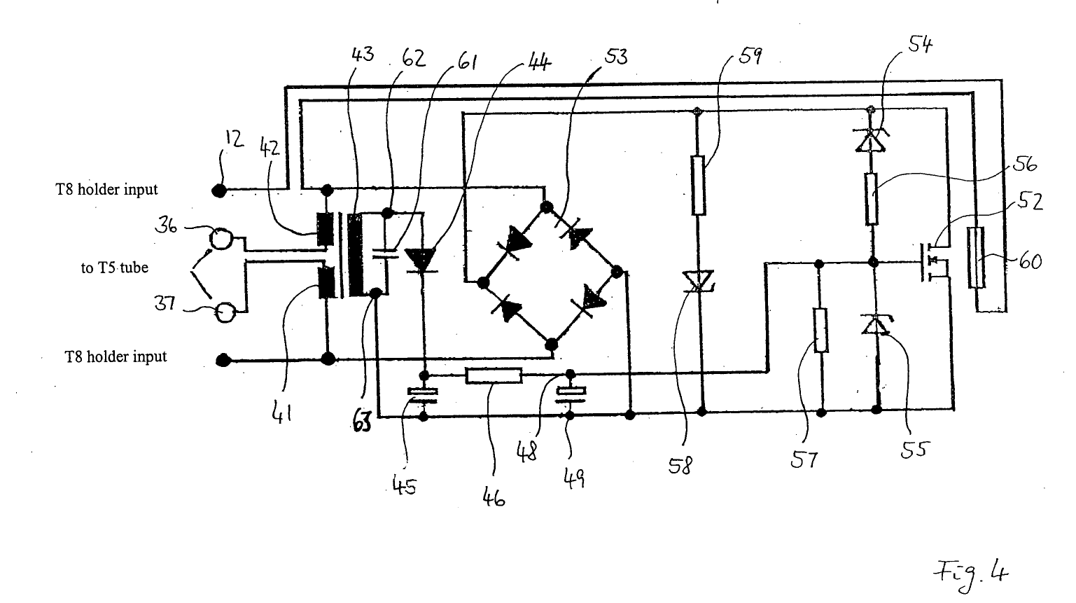

FIG. 4 shows electronic circuitry for control of the heat current of an incandescent filament at the end remote from the electronic ballast means of a T5 fluorescent tube in the other arrangement illustrated in FIG. 3.

FIG. 1 shows an arrangement for operating a modern T5 fluorescent tube 1 in a first T8 fluorescent tube holder 2 and a second T8 fluorescent tube holder 3. The first and second T8 fluorescent tube holders 2, 3 each comprise two receptacles 4, 5 and 6, 7, respectively. A first adapter 9 is disposed between a first end 8 of the T5 fluorescent tube 1 and the first TB fluorescent tube holder 2. A second adapter 11 is disposed between a second end 10 of the T5 fluorescent tube 1 and the second T8 fluorescent tube holder 3. Connecting pins 12 and 13, respectively, of the first adapter 9 are connected for electrical conduction to the receptacles 4 and 5, respectively, of the first T8 fluorescent tube holder 2. Similarly, connecting pins 14 and 15, respectively, of the second adapter 11 are connected for electrical conduction to the receptacles 6 and 7, respectively, of the second T8 fluorescent tube holder 3. An electronic ballast means 16 is arranged on the second adapter 11. Two connecting cables 17 and 18, respectively, connect a first connector socket 19 and a second connector socket 20 of the electronic ballast means 16 to the connecting pins 14 and 15 of the second adapter 11. In this way the electronic ballast means 16 is supplied with electrical voltage. The electronic ballast means 16 comprises a plurality of electronic components 21, 22, and 23; their concrete design may be selected by the skilled artisan for an electronic ballast known per se, depending on the particular case of application for energy-saving operation of the fluorescent tube. The electronic ballast means 16 generates a high frequency signal which is passed on through a third connector socket 24 and a fourth connector socket 25 via two leads 26 and 27 to receiving sockets 28 and 29 of the second adapter 11. A first incandescent filament 32 is connected electrically conductively to the high frequency signal by way of contact pins 30 and 31 of the second end 10 of the T5 fluorescent tube which pins are arranged in the receiving sockets 28 and 29. A second incandescent filament 33 at the first end 8 of the T5 fluorescent tube 1 is connected to electronic circuitry 38 through contact pins 34 and 35 and corresponding receptacles 36 and 37 of the first adapter 9. The electronic circuitry 38 likewise is connected to the connecting pins 12 and 13 of the first T8 fluorescent tube holder 2. It is required both for a hot start of the T5 fluorescent tube 1 and for smooth dimming operation of the T5 fluorescent tube 1 that the first incandescent filament 32 and the second incandescent filament 33 are heated. During undimmed continuous operation, on the other hand, the first incandescent filament 32 and the second incandescent filament 33 must not be heated. Synchronized heating of the first incandescent filament 32 and the second incandescent filament 33 is achieved, for instance, by transmitting a signal from an infrared light emitting diode 39 to a photosensitive diode 40, whereby the electronic circuitry 38 is caused to heat the second incandescent filament 33 or to stop heating it.

FIG. 2 illustrates an embodiment of the electronic circuitry 38. Like features are marked by the same reference numerals as in FIG. 1. A system voltage across receptacles 4 and 5 of the T8 fluorescent tube holder 2 is supplied to the electronic circuitry 38 at connecting pins 12 and 13 (cf. FIG. 1). This normally is the mains alternating current of 220 V.

The second incandescent filament 33 which is conductively connected to terminals 36 and 37 is supplied with heat current through two oppositely wound half-coils 41 and 42. Because of the opposed winding sense of the two half-coils 41 and 42, the heat current of the incandescent coil 33 (not shown in FIG. 2) does not induce voltage in a second coil 43. Voltage is induced in the second coil 43 only by the high frequency lamp current which flows through one of the two half-coils. The high frequency lamp current flows in and out through only one of the two terminals 12 or 13. The voltage induced in the second coil 43 is rectified by means of a diode 44. A charging capacitor 45 is charged by the induced direct voltage. A resistor 46 and a capacitor 47 act as a filter means.

A voltage differential occurring between points 48 and 49 of the circuit arrangement is determined by a drop in voltage across a resistor 50 and a photosensitive diode 51 (identical with the photosensitive diode 40 in FIG. 1) and depends on the incidence of light upon photodiode 51. The difference in voltage between points 48 and 49 is identical with the difference in voltage between a gate and a source of a field effect transistor 52. The field effect transistor 52 is a self-blocking end channel field effect transistor which is mounted so as to be thermally conductive. It will fully connect through at a voltage differential of about +5 V between gate and source. Once connected through, the field effect transistor 52 shortcircuits the second incandescent filament 33 (not shown in FIG. 2) between the terminals 36 and 37 through a bridge recitifer 53. Zener diodes 54 and 55 and a resistor 56 serve as voltage limiters. A resistor 57 serves to determine an operating point of the field effect transistor 52. A light emitting diode 58 together with a series resistor 59 supply optical information as to whether or not the circuit is operating correctly. In case of overheating of the field effect transistor 52, a fuse 60 positioned near the field effect transistor 52 interrupts the supply of current, so that a temperature safety-fuse is given.

FIG. 3 shows a second arrangement for energy-saving operation of a T5 fluorescent tube. In contrast to the arrangement as depicted in FIG. 1 there is no optical signal transmission path between the electronic circuitry 38 provided at the first adapter 9 and the electronic ballast means 16 provided at the second adapter 11. The task of the electronic circuitry 38 in the first adapter 9, to supply heat current, when needed, to the second incandescent filament 33 of the T5 fluorescent tube 1 is fulfilled here by electronic circuitry of which an embodiment is illustrated in FIG. 4.

FIG. 4 is a detailed presentation of an embodiment of the electronic circuitry 38 devised for use in the arrangement illustrated in FIG. 3. The same reference numerals in FIGS. 2 and 4 designate like features. As may be seen in FIG. 4, a capacitor 61 is arranged in parallel with the second coil 43. In this manner a parallel resonant circuit is obtained which is tuned such that a maximum voltage amplitude occurs between a point 62 and a point 63 at the high frequency of the lamp current at which the T5 fluorescent tube 1 generates a maximum light quantity. In the dimming mode, the frequency for operating the T5 fluorescent tube is increased still further. Under such circumstances the voltage amplitude occurring between points 62 and 63 decreases. This voltage amplitude influences the voltage differential between the gate and the source of the field effect transistor 52. The parallel resonant circuit formed by the second coil 43 and the capacitor 61 thus replaces the function of the photosensitive photodiode 51 provided in the circuit according to FIG. 2. Furthermore, the electronic circuitry shown in FIG. 4 comprises diodes 64 and 65 which prevent the current from flowing back. Otherwise the functioning of the electronic circuitry according to FIG. 4 is identical with that of the electronic circuitry described above with reference to FIG. 2.

When the fluorescent tube is turned on there is not yet a high frequency signal at the inputs of the T8 fluorescent tube holder. Low frequency current (50 Hz mains current) flows through the half-coils 41 and 42 and also through the second incandescent filament 33 which is connected to the terminals 36 and 37. After firing of the T5 fluorescent tube, high frequency current flows through both half-coils 41 and 42. Hereby, voltage is induced in the parallel resonant circuit formed by the coil 43 and the capacitor 61. The charging capacitor 45 is charged, and the voltage at the charging capacitor 45 is smoothed by means of the resistor 46 and the capacitor 47. The capacitor 47, additionally, acts as a timing delay.

The voltage induced in the parallel resonant circuit causes a positive voltage differential between the gate and the source of the field effect transistor 52. Thereby, the field effect transistor 52 is connected through to shortcircuit the second incandescent filament 33 (not shown in FIG. 4) between the terminals 36 and 37 by way of the bridge rectifier 53. Consequently, when the field effect transistor 52 is connected through, heat current no longer flows through the second incandescent filament 33 which is connected to the terminals 36 and 37.

In the dimming range, the frequency is raised at which the T5 fluorescent tube is operated. That causes the voltage induced in the resonant circuit to drop. A reduction of the induced voltage, at the same time, leads to a decrease of the difference in voltage between the gate and the source of the field effect transistor 52. As the voltage differential between gate and source goes down, the field effect transistor 52 begins to block. Under these circumstances the second incandescent filament 33 (not shown in FIG. 4) is not short-circuited any longer through the bridge rectifier 53 so that, once again, heat current can flow through the second incandescent filament 33 which is connected to the terminals 36 and 37. A resistance value within the order of magnitude of the resistance value of the incandescent filament may be allocated to the branch including the field effect transistor. Part of the current thus flows through the field effect transistor and another part through the incandescent filament. The heat current flowing through the second incandescent filament 33, therefore, is inversely proportional to the current flowing through the field effect transistor 52.

The features of the invention disclosed in the specification above, in the claims and the drawing may be important for implementing the invention in its various embodiments, both individually and in any combination.

1. An energy-saving operating method for a fluorescent tube, the method comprising the following steps:
applying heat current to an incandescent filament at one end of the fluorescent tube, in a first operating mode, the incandescent filament being connected to electronic energy-saving circuitry;
applying another heat current to another incandescent filament at an end opposite to said one end of the fluorescent tube, the other incandescent filament being connected to electronic circuitry which is separate from the electronic energy-saving circuitry; and
interrupting the application of the heat current and the other heat current to the incandescent filament and the other incandescent filament, respectively, in a second operating mode;
wherein an operating parameter of the other incandescent filament is monitored, in the first and second operating modes, by monitoring means which are comprised by the electronic circuitry so as to control a time period of application of the other heat current to the other incandescent filament in dependence on a time period of application of the heat current to the incandescent filament by means of the electronic circuitry in response to the operating parameter being monitored.

2. The method as claimed in claim 1, wherein the operating parameter being monitored of the other incandescent filament is a maintaining voltage dependent on frequency at the other incandescent filament.

3. The method as claimed in claim 2, wherein a voltage dependent on frequency and induced in a resonant circuit is utilized for monitoring the frequency of the maintaining voltage.

4. The method as claimed in any claim 1,
wherein in the first operating mode, the fluorescent tube is operated in a dimming mode.

5. An apparatus for energy-saving operation of a fluorescent tube, especially a T5 fluorescent tube, comprising:
electronic energy-saving circuitry adapted to be coupled to an incandescent filament at one end of the fluorescent tube to control application of heat current to the incandescent filament; and
electronic circuitry, separate from the electronic energy-saving circuitry, adapted to be coupled to another incandescent filament at an end opposite to said one end of the fluorescent tube to control application of another heat current to said other incandescent filament;
the electronic circuitry comprising monitoring means to monitor an operating parameter of said other incandescent filament so that switch-on/switch-off of the application of the other heat current to the other incandescent filament can be controlled in dependence on the switch-off/switch-on of the application of the heat current to the incandescent filament by means of the electronic circuitry in response to the operating parameter being monitored.

6. The apparatus as claimed in clam 5, wherein the monitoring means comprise means for monitoring a frequency of a maintaining voltage applied to the other incandescent filament.

7. The apparatus as claimed in claim 6, wherein the means for monitoring the frequency of the maintaining voltage applied to the other incandescent filament comprise a resonant circuit.

8. An apparatus for coupling to an incandescent filament of a fluorescent tube, comprising electronic circuitry for controlling the application of heat current to the incandescent filament in dependence on the operating mode, the electronic circuitry comprising monitoring means to monitor a frequency of a maintaining voltage at the incandescent filament so that the application of heat current to the incandescent filament can be switched on in a first mode of operation and interrupted in a second mode of operation by means of the electronic circuitry in response to the frequency being monitored.

9. (Canceled)
